(19) United States
(12) Patent Application Publication
(10) Pub. No.: US 2003/0050042 A1
(43) Pub. Date: Mar. 13, 2003

(54) Method for billing short messages in a mobile radio network and device for carrying out the method

(76) Inventor: Geza Olah, Budapest (HU)

Correspondence Address: Morrison & Foerster LLP, 1650 Tysons Boulevard, Suite 300, McLean, VA, 22102, US

(21) Appl. No.: 10/195,358

(22) Filed: Jul. 16, 2002

(30) Foreign Application Priority Data
Jul. 17, 2001 (DE) 10134588.7

(51) Int. Cl. H04M 11/00; H04Q 7/20

(52) U.S. Cl. 455/406; 455/466

(57) ABSTRACT

Information is billed together with the billing of a request message for the information. The request message includes combined billing, namely, firstly, the billing for the sending out of the message itself and secondly the billing of the requested information. This type of billing of the information is particularly advantageous in the case of premium services, where the amounts of charges are up to ten times the normal charges.

### CLAIM FOR PRIORITY

This application is based on German application 10134588.7 filed on Jul. 17, 2001.

### TECHNICAL FIELD OF THE INVENTION

The invention relates to a method for billing short messages in a mobile radio network, for example in a GSM network, and to a device for carrying out the method.

### BACKGROUND OF THE INVENTION

In digital mobile radio systems, the short message service, also called SMS, has in the meantime become successful in addition to voice and data transmission. A terminal, as a rule the keypad of the mobile telephone, can be used for inputting a message of restricted length (for example 160 characters) and then sent out via the mobile radio network.

A description of the mechanisms for the technical implementation of the short message service can be found in the specification GSM 03.40 (identical to ETSI TS 100 901): “Digital cellular telecommunications system, technical realization of the Short Message Service” for the GSM network.

However, these specifications do not deal with the charging for these services offered and, as a rule, the charging is implemented by the network operators in proprietary solutions.

Using short messages has become very popular in recent years. By now, this service is also used for requesting information, for example for timetable information or as concerts.

At present, short messages are billed uniformly, that is independently of the time and of where the transmitter and receiver are located (in the home network). The amount of the charge only depends on the short message service center (SMSC) used in the network. A charge ticket generated in the network contains the charge information and it is usually the sender of the short message who is billed for the charge.

For conventional connections in a mobile radio network, the so-called “premium rate service” is already known which makes it possible to bill the caller (client) with an additional fee for the service in addition to the charge for the connection. In this case, however, the information is transmitted in the same connection which was set up by the caller.

A service provider who wishes to provide his client with information on demand via SMS, however is scarcely able at present to obtain a fee for this service as well. An exception, at best, are banking institutes which can deduct a usage fee directly from the account of the client using the service. Other methods such as transfers are too expensive, as a rule, and are also too complicated in relation to the amounts involved, which are rather small in most cases.

From the document WO 98/56202 (Billing Mobile Terminated Short Messages), a method is described in which short messages received by the mobile terminal (so-called “mobile terminated short messages”) are billed at the receiver. This is made possible by sending a proposal for charging information along with the short message. Furthermore, a short message service center SMSC is described which is suitable for generating a charge ticket by means of the charging generating a charge ticket by means of the charging information contained in the short message.

### SUMMARY OF THE INVENTION

The invention provides for flexible billing of short messages, and permits service providers the ability to obtain appropriate reimbursement for information sent out.

In one embodiment of the invention, information is already billed together with the billing of the request message for the information. The request message includes for example billing, e.g. the billing for the sending out of the message itself and the billing of the requested information. This type of billing of the information is particularly advantageous in the case of premium services, where the amounts of charges are up to ten times the normal charges.

Another advantageous embodiment of the invention provides that the request message is sent in the form of a short message (SMS—Short Message Service). Furthermore, the request message can be billed dependent on the destination number addressed in it. In a further embodiment, there is a prescribed syntax for the request message. The syntax can include a blank message, e.g. a blank short message is sent to the destination number. This procedure makes it possible to avoid syntax errors in the request message.

If the services requested are information, it is advantageous to send the information back to the client in a short message. Since a short message is limited to 160 characters, it should be of no concern in how many individual short messages the response is sent back to the client.

In another embodiment, clients who prefer so-called prepaid solutions are also able to request such information. In this case, the charges incurred will be deducted from the credit account of the client.

Furthermore a service switching point (SSP) in a so-called intelligent network belongs to the solution according to the invention (see also telecommunication standards Q.1200 ff ITU). This service switching point is able to detect a request message and to check whether this is a so-called premium rate number.

In addition, a service control point (SCP) which is connected to the service switching point (SSP), also belongs to the solution according to the invention. The service control point is informed by the service switching point if this is a short message for requesting information which is to be separately billed. At the service control point, the corresponding charge tickets for this special billing are then generated and sent out.

The invention may also be used in information services, for example for calling up stock market information or flight information. In this context, many embodiments are possible. For example, it is possible to call up the stock market price of a single share, the price of the share index DAX or also a list of share prices depending on the syntax of the request message.

It is also possible, for example, that a requested information item is sent with a time delay. In this context, a flight information service can be mentioned in which a planned departure time is reported, for example 2 hours before departure. In this case, it is also possible that no response message is generated. Another advantageous embodiment of the invention, therefore, is that the request message is first answered with an acknowledgement message before the actual information is transmitted to the client.

### BRIEF DESCRIPTION OF THE DRAWINGS

In the text which follows, the invention will be explained with reference to exemplary embodiments. In the figures:

FIG. 1 shows the structure of a conventional intelligent network according to telecommunications standard ITU Q.1200.

FIG. 2 shows the sequence of a communication between a client and a service provider, i.e. information provider.

FIG. 3 shows the communication sequence in an intelligent network, particularly the writing of charge tickets.

FIG. 4 shows the determination of tariff information for sending out short messages according to the prior art.

FIG. 5 shows the determination of tariff information for short messages according to the invention.

### DETAILED DESCRIPTION OF THE PREFERRED EMBODIMENTS

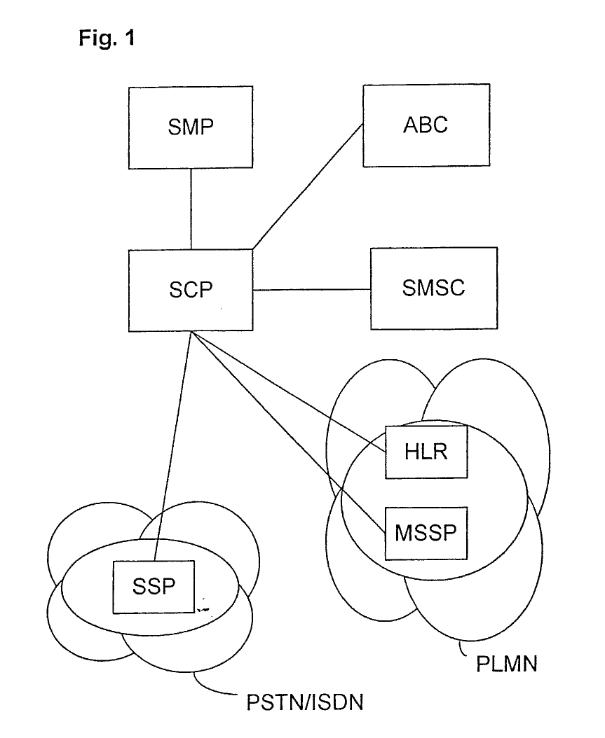

FIG. 1 shows the network elements of the invention. The network can be accessed via landline network (PSTN—Public Switch Telephone Network) or mobile radio network (PLMN—Public Land Mobile Network). For this purpose, switching centers such as the SSP or MSSP for the mobile radio network are provided. In the mobile radio network, a home location register (HLR) is also preferable.

A service control point (SCP) is responsible for administering the network nodes. These service control points are central control points of the network and include the service logic of the control level responsible for the process of connection. The essential task of the SCP is translating the directory number into a real address and executing the applications, receiving and forwarding connection information to the switching computer and charges and data acquisition and statistics.

Short messages sent by the subscriber are first stored in the so-called short message service center (SMSC). From there, they are delivered to the receiver addressed. The precise manner of delivery will not be specified further in the text which follows since it can already be seen in the standards. At present, charging is not specified in the standards and is done by means of proprietary solutions of the manufacturer.

Billing is done by automatic message accounting (AMA) tickets. After the connection has been cleared down, a ticket is generated which is sent to the processing center, called ABC (Administration and Billing Center) in this case, and is collected there. As a rule, billing is a matter for the network operator or service provider. It can, therefore, also take different forms in different networks. When short messages are sent out, the billing is done independently of distance.

The service management point (SMP) handles the network management functions. It supports distributed processsing and database organization functions and is connected to the SCPs via X.25 or a similar protocol. The service management point is centrally responsible for updating the data and software in the SCPs throughout the network. Thus, new IN services or features can be generated here and introduced into the existing network as program systems.

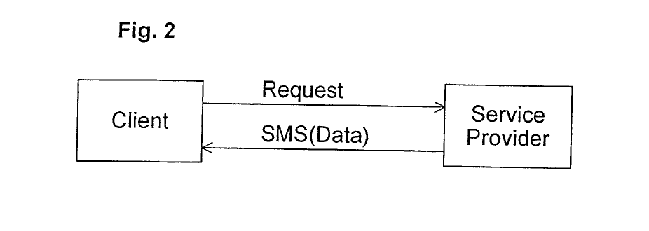

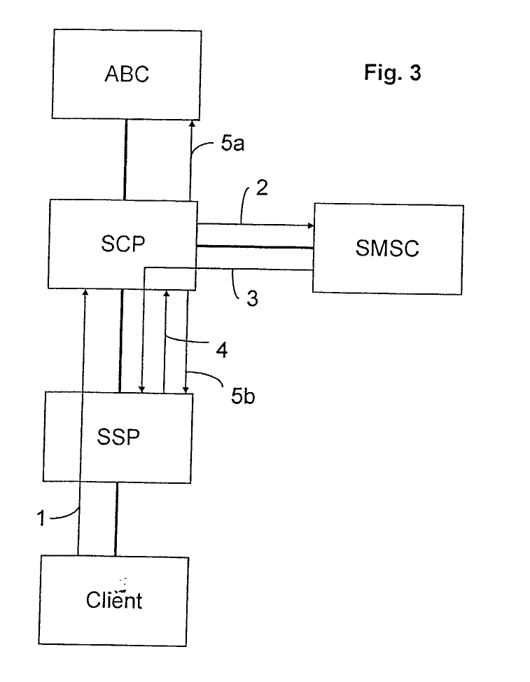

FIG. 2 shows how the communication between client and service provider is intended to proceed. The client sends an information request message to the service provider. The service provider then answers the client with the response (SMS). This can be either an information item or a service or an item of goods. For example, the requesting of a stock market price or of current information such as movie theater program, television program, timetable information, etc. FIG. 3 then shows the sequence of billing for information interrogation.

FIG. 3 shows the procedure of billing in the premium-rate SMS service according to the invention, particularly with so-called contractual clients. An NTS (Number Translation Service such as Free Phone, Premiumrate and Universal Access Number) service has two fundamental functions: flexible routing and flexible charging. The NTS services are also offered by mobile network operators which at present, however, do not support a premium-rate SMS. According to the invention, these functions are now extended to SMS. The technical implementation of billing for this is described.

Billing party A in the case of premium-rate services is done under IN control by means of SCI (Send Charging Information). The crediting of the part of the charge provided to the service subscriber by the operator is done by writing so-called IN-AMA tickets (see above).

The charges for the SMS messages have been debited uniformly, that is after successful storage of the SMS in an SMSC, the uniform charge is debited. In the solution according to the invention short messages (SMS) are sent through a switching center (which must be an FST in this case) of the relevant SMSC (1, 2). The preferable solution is to simply debit the standard SMS charge as previously—after completed storage of the short message in an SMSC (not necessarily under IN control). The “additional price” is then debited with the aid of the IN system. In this case, the conventional mechanism of billing the SMS at the SSP/SMSC is not eliminated.

When the SSP receives the information on the successful storage of the SMS, 3, it checks whether this is a premium-rate number. If it is, a corresponding INAP (Intelligent Network Application Part) message is sent to the service control point (SCP) 4. This initiates the premium-rate billing at the SCT. The SCP generates an IN AMA ticket for crediting the part-charge to the service subscriber (5a), and an SCI (Send Charging Information) INAP message is sent back to the SSP (5b). This initiates the additional billing of the A party.

For the prepaid service, which means that the client has set up a credit account, the solution looks slightly different. The short message service tariff model is also extended with the destination-dependent billing. The destination address dialed (CdPA) is accessible to the service. As the same possibility for administration as already exists for the MOC (Mobile Originating Call) tariff model can be implemented for the SMS tariff model, this means that destination zones can be defined where the destination numbers which are to be billed identically can be combined. For the SMS tariff model, it is not absolutely necessary to define a separate list of destination zones since the individual destination numbers in most cases belong to the same billing category. If it is a matter of calls or short messages, the list defined for the mobile originating call tariff model can also be used for short messages. There will be further requirements for a destination number at another operator or in a foreign country.

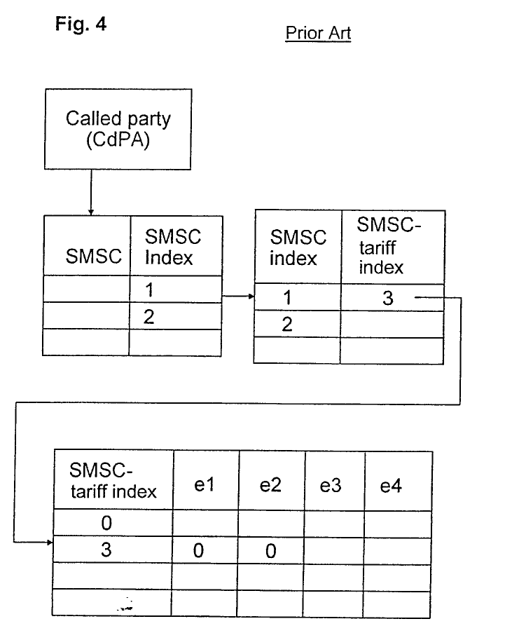

FIG. 4 shows the billing which is already carried out with the sending-out of short messages. The service logic in the switching point looks for the address of the short message service center (SMSC) in a list of possible SMSCs. This list includes an SMSC index. If the required SMSC is not found in the list, the index is set to zero. This SMSC index is converted into an SMSC tariff index. The result is that the billing of a short message can already look different closely depending on the SMSC already used. The SMSC tariff index, in turn, points to a length of E parameters and the actual tariff information can then be taken from this table.

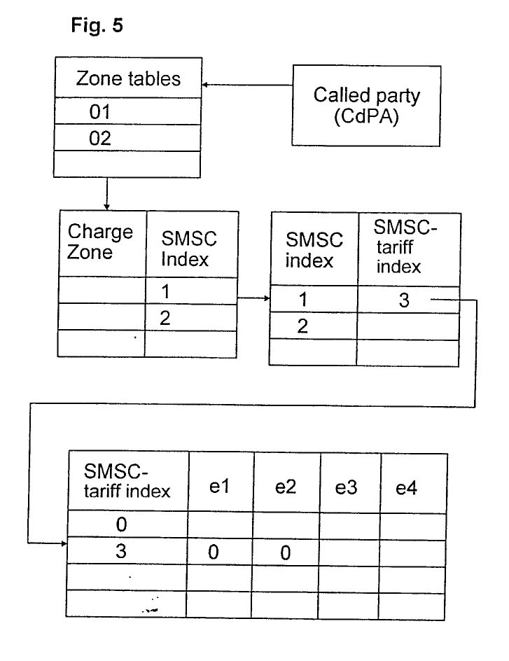

FIG. 5 then shows how billing is carried out for short messages in dependence on the destination number, on the basis of FIG. 4. In this context, a tariff model is assumed which is similar to the mobile originating tariff call tariff model in which a set of E parameters is dependent on the destination zone and a time window, that is to say it is time-dependent. If destination-number-dependent billing of short messages is possible, premium-rate numbers of a particular charge can be combined in a group and a set of E parameters which represents a higher charge can then be allocated to this destination zone.

Naturally, the charges can be configured. The tariff mapping table (at provider level) is completed with relevant premium-rate SMS tariffs. The tariff of the individual premium-rate SMS number (at subscriber level) is then defined in accordance with these tariff IDs. When the charging matrix for the subscriber is defined, the tariffs of the individual call segments can be specified at present. The SMS can in this case be defined as a new call segment. It is preferable to use one of the previously unused call segments for the SMS messages.

What is claimed is:

1. A method for billing costs for sending out information, services or goods to a client via a mobile radio network, comprising:
sending a request message to a service provider to obtain required information, services or goods from the provider, wherein charges for the request message include at least one charge for sending out the request message and costs for the information, services or goods to the client.

2. The method as claimed in claim 1, wherein the request message is a short message.

3. The method as claimed in one of claim 1, wherein the request message is structured in accordance with a predetermined syntax, where the syntax includes a blank message.

4. The method as claimed in claim 1, wherein the client requests information and the client receives an answer in the form of a short message which includes the information requested by the client.

5. A method for billing costs for sending out information to a client via a mobile radio network, comprising:
sending a request message addressed to a provider; and
receiving the required information, services or goods from the provider, wherein
the client sends out a short message as the request message, and
debiting of charges for the short message includes costs for the requested information, services or goods, and the costs are based on the destination number addressed.

6. The method as claimed in claim 5, wherein the costs debited to the client are subtracted from a credit account.

7. The method as claimed in claim 5, wherein the destination numbers addressed are combined in destination zones and individual destination numbers of a destination zone are billed at the same level.

8. A device for sending messages to a client via a mobile radio network, comprising:
a first device for receiving a short message;
a second device for checking the short message by a destination number; and
a third device for sending a billing message to a service center in the network for carrying out joint billing for a charge for the requested information and a charge for sending out the information request.

9. A device for sending messages to a client via a mobile radio network, comprising:
a first device for receiving a billing message;
a second device for sending a first charge message for billing for a charge for requested information; and
a third device for sending a second charge message for billing for the sending-out of the information request.

10. The method as claimed in one of claim 2, wherein the request message is structured in accordance with a predetermined syntax, where the syntax includes a blank message.

11. The method as claimed in claim 2, wherein the client requests information and the client receives an answer in the form of a short message which includes the information requested by the client.

12. The method as claimed in claim 3, wherein the client requests information and the client receives an answer in the form of a short message which includes the information requested by the client.

13. The method as claimed in claim 6, wherein the destination numbers addressed are combined in destination zones and individual destination numbers of a destination zone are billed at the same level.
